(19) United States
(12) Patent Application Publication
(10) Pub. No.: US 2026/0155439 A1
(43) Pub. Date: Jun. 4, 2026

(54) ELECTROLYTE FOR LITHIUM METAL BATTERY AND LITHIUM METAL BATTERY INCLUDING THE SAME

(71) Applicant: KOREA ADVANCED INSTITUTE OF SCIENCE AND TECHNOLOGY, Daejeon (KR)

(72) Inventors: Jiheong KANG, Daejeon (KR); Hyunjun KIM, Daejeon (KR)

(21) Appl. No.: 19/384,331

(22) Filed: Nov. 10, 2025

(30) Foreign Application Priority Data
Dec. 2, 2024 (KR) 10-2024-0176688

(51) Int. Cl. H01M 10/0565; C08F 290/06; H01M 10/0525; H01M 10/0567

(52) U.S. Cl. CPC H01M 10/0565; C08F 290/062; H01M 10/0525; H01M 10/0567; H01M 2300/0025

(57) ABSTRACT

Provided are an electrolyte for a lithium metal battery and a lithium metal battery including the same. The electrolyte for the lithium metal battery includes a lithium salt; an organic solvent; and a bottlebrush polymer comprising a repeating unit represented by Chemical Formula 1, wherein the bottlebrush polymer has a bottlebrush-shaped structure in which side chains included in the repeating unit are connected to a backbone included in the repeating unit and are arranged in an outward direction, and the spacing between the side chains is evenly arranged, and a packing density of side chains defined by the value of x/(x+y) in Chemical Formula 1 is ⅛ to 1.

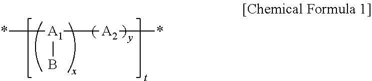

(In Chemical Formula 1, A₁, A₂, B, x, y, and t are as defined in the specification.)

### CROSS-REFERENCE TO RELATED APPLICATION

This application claims priority to and the benefit of Korean Patent Application No. 10-2024-0176688 filed with the Korean Intellectual Property Office on Dec. 2, 2024, the entire contents of which are incorporated herein by reference.

### BACKGROUND OF THE INVENTION

### (a) Field of the Invention

The present disclosure relates to an electrolyte for a lithium metal battery and a lithium metal battery including the same.

### (b) Description of the Related Art

A lithium metal battery is battery that uses a lithium metal or a lithium alloy as a negative electrode, and it has a very high energy capacity.

However, a lithium metal battery may form lithium dendrites, which are dendritic deposits, due to uneven current distribution on the surface of the lithium negative electrode, causing lithium to be deposited only in certain regions. These lithium dendrites can reach a positive electrode and risk shorting out the battery or causing it to explode. Improvements in the safety and lifespan of the lithium metal battery are required.

### SUMMARY OF THE INVENTION

An embodiment provides an electrolyte for a lithium metal battery having excellent cycle stability by improving lithium ion conductivity due to excellent lithium ion deposition characteristics on a negative electrode surface.

Another embodiment provides a lithium metal battery including the electrolyte for a lithium metal battery.

An embodiment provides an electrolyte for a lithium metal battery including a lithium salt; an organic solvent; and a bottlebrush polymer comprising a repeating unit represented by Chemical Formula 1, wherein the bottlebrush polymer may have a bottlebrush-shaped structure in which side chains included in the repeating unit are connected to a backbone included in the repeating unit and are arranged in an outward direction, and the spacing between the side chains may be evenly arranged, and a packing density of side chains defined by the value of x/(x+y) in Chemical Formula 1 may be about ⅛ to about 1.

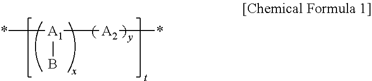

(In Chemical Formula 1,
A₁ and A₂ may each independently be a backbone which is a linking group formed by ring opening of norbornene or a norbornene derivative, or a linking group derived from acrylate,
B may be side chains which are a substituted or unsubstituted C1 to C20 alkyl group, wherein at least one —CH₂— of the alkyl group may be replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R may be a substituted or unsubstituted C1 to C20 haloalkylene group,
x may be an integer ranging from about 1 to about 500,
y may be an integer ranging from about 0 to about 500,
t may be an integer ranging from about 1 to about 500.)

The bottlebrush polymer may include a repeating unit in which y is about 0 to about 7 when x is about 1 in Chemical Formula 1.

The packing density of side chains may be about ¼ to about 1.

The bottlebrush polymer may have a structure in which the side chains adjacent to each other are arranged in different directions facing outward.

The bottlebrush polymer may have a flexible-bent structure or a rigid-rod-like structure.

The bottlebrush polymer may include at least one of a compound including a structural unit represented by Chemical Formula 2, a compound including a structural unit represented by Chemical Formula 3, and a compound including a structural unit represented by Chemical Formula 4.

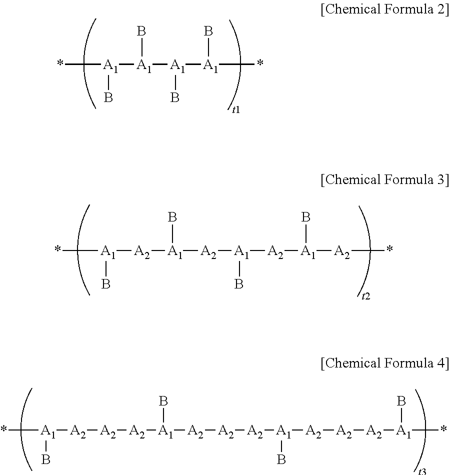

(In Chemical Formulas 2 to 4,
A₁, A₂ and B may be the same as defined in Chemical Formula 1, and
t1 to t3 may each be an integer ranging from about 1 to about 500.)

The bottlebrush polymer may include at least one of a repeating unit represented by Chemical Formula 5 and a repeating unit represented by Chemical Formula 6.

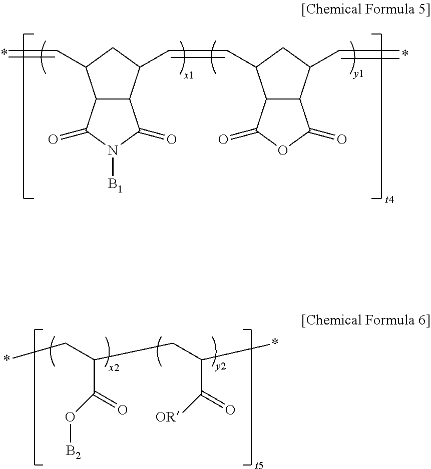

(In Chemical Formulas 5 and 6,
R′ may be a substituted or unsubstituted C1 to C20 alkyl group,
B₁ and B₂ may each be side chains which are a substituted or unsubstituted C1 to C20 alkyl group, wherein at least one —CH₂— of the alkyl group may be replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R may be a substituted or unsubstituted C1 to C20 haloalkylene group,
x1 and x2 may each be an integer ranging from about 1 to about 500,
y1 and y2 may each an integer ranging from about 0 to about 500, and
t4 and t5 may each an integer ranging from about 1 to about 500.)

In Chemical Formula 1, B may include a substituent derived from at least one compound selected from the group consisting of polyethylene glycol, polypropylene glycol, polycarbonate, polycaprolactone, and perfluoropolyether.

In Chemical Formula 1, B may include at least one substituent selected from Chemical Formulas 7-1 to 7-6.

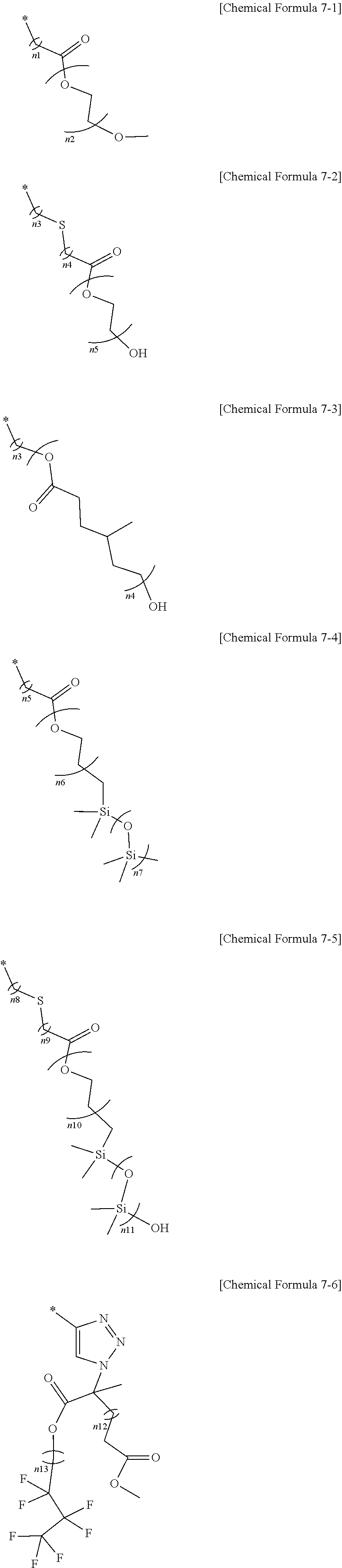

(In Chemical Formulas 7-1 to 7-6,
n1 to n13 may each be an integer ranging from about 1 to about 20.)

The bottlebrush polymer may be included in an amount of about 0.1 wt % to about 20 wt % based on a total amount of the electrolyte.

The lithium salt may include at least one of LiSCN, LIN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

The organic solvent may include at least one selected from the group consisting of propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, 1,3-dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, and dimethyl ether.

The electrolyte may further include an ionic liquid.

The ionic liquid may include at least one selected from compounds including i) at least one cation selected from the group consisting of ammonium, pyrrolidinium, pyridinium, pyrimidinium, imidazolium, piperidinium, pyrazolium, oxazolium, pyridazinium, phosphonium, sulfonium, and triazolium, and ii) at least one anion selected from the group consisting of BF₄⁻, PF₆⁻, AsF₆⁻, SbF₆, AlCl₄⁻, HSO₄⁻, ClO₄⁻, CH₃SO₃, CF₃CO₂⁻, Cl⁻, Br⁻, I⁻, F⁻, SO₄⁻, CF³SO₃⁻, (FSO₂)₂N⁻, (C₂F₅SO₂)₂N⁻, (C₂F₅SO₂)(CF₃SO₂)N⁻, and (CF₃SO₂)₂N⁻.

Another embodiment provides a lithium metal battery including a negative electrode comprising a lithium metal or a lithium metal alloy; a positive electrode; and the electrolyte disposed between the negative electrode and the positive electrode.

An electrolyte for a lithium metal battery according to an embodiment may have a characteristic of allowing lithium ions to be uniformly and densely deposited on a surface of a negative electrode, thereby securing a lithium metal battery having excellent lithium ion conductivity, low overvoltage, and stable cycle performance.

### BRIEF DESCRIPTION OF THE DRAWINGS

FIG. 1 is a schematic view of an example structure of a bottlebrush polymer according to an embodiment.

FIG. 2 is a schematic view explaining a change in the structure of a bottlebrush polymer depending on a packing density of side chains according to an embodiment.

FIG. 3 is a schematic view showing the structure of a bottlebrush polymer according to a packing density of side chains according to an embodiment.

FIG. 4 is a schematic view showing the degree of coordination bonding with lithium ions depending on the structure of a bottlebrush polymer according to an embodiment.

FIG. 5 is an NMR spectrum of the bottlebrush polymer synthesized in Synthesis Example 1.

FIG. 6 is an NMR spectrum of the bottlebrush polymer synthesized in Synthesis Example 2.

FIG. 7 is an NMR spectrum of the bottlebrush polymer synthesized in Synthesis Example 3.

FIGS. 8A and 8B are each a scanning electron microscope (SEM) analysis image showing the surface of lithium metal negative electrodes according to Example 1 and Comparative Examples 1 and 2.

FIGS. 9A and 9B are each a scanning electron microscope (SEM) analysis image showing the surface of lithium metal negative electrodes according to Examples 1 to 3.

FIG. 10 is a graph showing the cycle performance of lithium metal batteries according to Example 1 and Comparative Examples 1 and 2.

FIG. 11 is a graph showing the cycle performance of lithium metal batteries according to Examples 1 to 3.

FIG. 12 is a graph of electrochemical impedance spectroscopy (EIS) analysis of lithium metal batteries according to Example 1 and Comparative Examples 1 and 2.

FIG. 13 is a graph of electrochemical impedance spectroscopy (EIS) analysis of lithium metal batteries according to Examples 1 to 3 and Comparative Example 1.

FIG. 14 is a graph showing the viscosity of the electrolytes according to Example 1 and Comparative Examples 1 and 2.

FIG. 15 is a ⁷Li NMR analysis diagram of the electrolytes according to Example 1 and Comparative Examples 1 and 2.

FIG. 16 is a ⁷Li NMR analysis diagram of the electrolytes according to Examples 1 to 3 and Comparative Example 1.

FIG. 17 is a graph showing the rate capability of lithium metal batteries according to Examples 1 to 3 and Comparative Examples 1 and 2.

FIG. 18 is a graph showing the cycle durability of lithium metal batteries according to Examples 1 to 3 and Comparative Examples 1 and 2.

FIG. 19 is a graph showing voltage changes over time in lithium metal batteries according to Examples 1 to 3 and Comparative Examples 1 and 2.

FIG. 20 is a graph showing the coulombic efficiency of lithium metal batteries according to Examples 1 to 3 and Comparative Examples 1 and 2.

FIG. 21 is a graph showing the nucleation overvoltage of lithium metal batteries according to Example 1 and Comparative Examples 1 and 2.

FIG. 22 is a graph showing the exchange current density of lithium metal batteries according to Example 1 and Comparative Examples 1 and 2.

FIG. 23 is a graph showing the exchange current density of lithium metal batteries according to Examples 1 to 3 and Comparative Example 1.

FIG. 24 is a Raman spectrum analysis diagram of the electrolytes according to Examples 1 to 3 and Comparative Example 1.

### DETAILED DESCRIPTION OF THE EMBODIMENTS

Hereinafter, embodiments of the present disclosure will be described in detail so that a person skilled in the art would understand the same. This disclosure may, however, be embodied in many different forms and is not construed as limited to the embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

As used herein, when specific definition is not otherwise provided, “substituted” refers to replacement of a hydrogen of a compound by a substituent of a halogen atom, a hydroxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C30 alkyl group, a C2 to C30 alkenyl group, a C2 to C30 alkynyl group, a C6 to C30 aryl group, a C7 to C30 arylalkyl group, a C1 to C30 alkoxy group, a C1 to C20 heteroalkyl group, a C3 to C20 heteroaryl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, or a combination thereof.

Hereinafter, an electrolyte for a lithium metal battery according to an embodiment is described.

An electrolyte for a lithium metal battery according to an embodiment includes a lithium salt; an organic solvent; and a bottlebrush polymer.

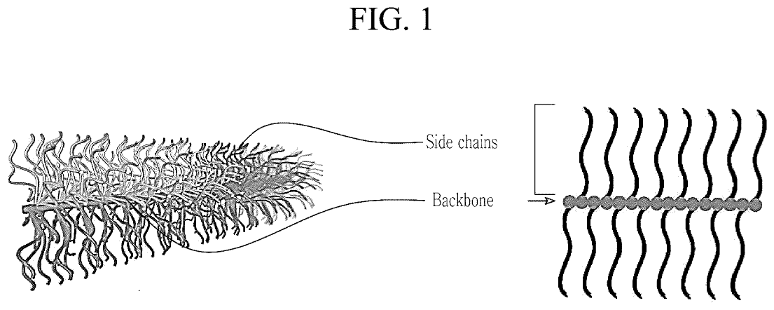

Hereinafter, a structure of the bottlebrush polymer will be described with reference to FIGS. 1 to 3.

FIG. 1 is a schematic view of an example structure of a bottlebrush polymer according to an embodiment.

Referring to FIG. 1, a bottlebrush polymer according to an embodiment is a polymer including a backbone and side chains, and has a bottlebrush-shaped structure in which side chains are connected to a backbone and are arranged in an outward direction, and the spacing between the side chains is evenly arranged. The spacing between side chains refers to the distance between adjacent side chains within a single polymer including a backbone and side chains. A bottlebrush polymer according to an embodiment may have a structure in which the side chains are arranged with a constant spacing between adjacent side chains.

Specifically, the bottlebrush polymer may have a structure in which adjacent side chains are arranged outwardly in different directions.

Here, the constant spacing between side chains is applicable to all side chains that are close to each other and connected to the backbone, regardless of the direction of the side chains.

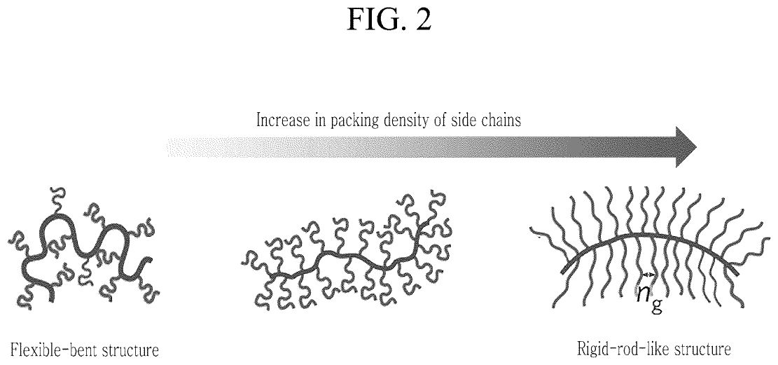

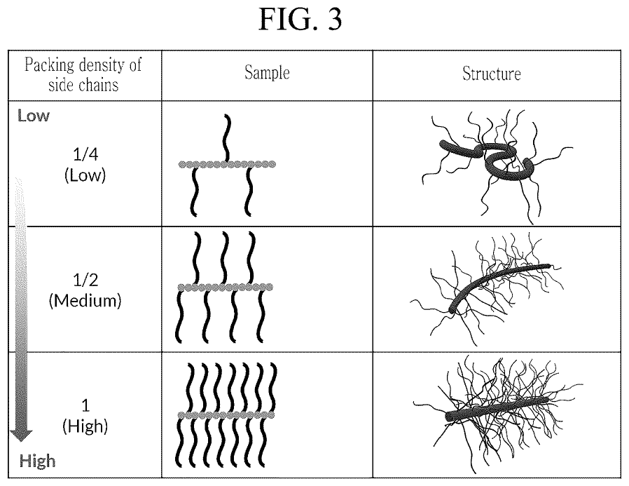

FIG. 2 is a schematic view explaining a change in the structure of a bottlebrush polymer depending on a packing density of side chains according to an embodiment. FIG. 3 is a schematic view showing the structure of a bottlebrush polymer according to a packing density of side chains according to an embodiment.

A packing density of side chains indicates how densely the side chains are arranged within one repeat unit of a polymer.

Referring to FIGS. 2 and 3, the bottlebrush polymer can have various structures depending on the packing density of side chains. That is, the bottlebrush polymer can have a flexible-bent structure when the packing density of side chains is relatively low, and can have a rigid-rod-like structure when the packing density of side chains is relatively high.

In other words, the larger the spacing (ng) between side chains, the lower the packing density of side chains, so that the bottlebrush polymer can have a more flexible-bent structure, and the smaller the spacing (ng) between side chains, the higher the packing density of side chains, so that it can have a rigid rod-like structure.

The packing density of side chains can be expressed as the ratio of the number of side chains connected to the backbone per backbone at a regular interval within one repeating unit of the bottlebrush polymer. In FIG. 3, it can be seen that when the packing density of side chains is, for example, about ¼, the spacing between the side chains is relatively large, resulting in a more flexible-bent structure. In addition, when the packing density of side chains is, for example, about 1, the spacing between the side chains is relatively small, and thus the flexibility is lowered, and it can be seen that it has a rigid-rod-like structure.

The bottlebrush polymer may have, for example, the flexible-bent structure.

According to an embodiment, when the bottlebrush polymer having such various structures is used in an electrolyte of a lithium metal battery, specifically, when used as an additive in an electrolyte for a lithium metal battery, the bottlebrush polymer helps lithium ions to be deposited uniformly and densely during the deposition process of lithium ions on a surface of a negative electrode, thereby improving lithium ion conductivity. Accordingly, a lithium metal battery with improved cycle stability can be obtained.

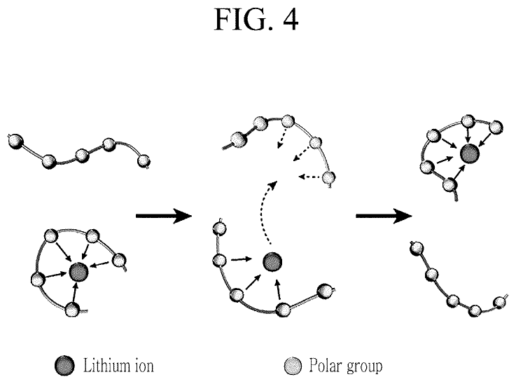

FIG. 4 is a schematic view showing the degree of coordination bonding with lithium ions depending on the structure of a bottlebrush polymer according to an embodiment.

Referring to FIG. 4, since the bottlebrush polymer includes a polar group that acts as an electron donor in the side chains, the polar group can conduct lithium ions by coordinating with lithium ions. For example, the bottlebrush polymer having a flexible-bent structure due to a low packing density of side chains can further improve lithium ion conductivity due to a high degree of coordination bonding with lithium ions. In other words, the bottlebrush polymer according to an embodiment has a structure that allows for good solvation of lithium ions within the electrolyte.

The bottlebrush polymer includes a repeating unit represented by Chemical Formula 1.

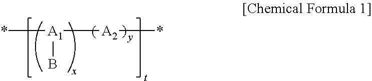

In Chemical Formula 1, A₁ and A₂ represent a backbone. A₁ and A₂ can each independently be a linking group formed by ring opening of norbornene or a norbornene derivative, or a linking group derived from acrylate.

In Chemical Formula 1, B represents side chains. B can be a substituted or unsubstituted C1 to C20 alkyl group, wherein at least one —CH₂— of the alkyl group can be replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R can be a substituted or unsubstituted C1 to C20 haloalkylene group. That is, the side chains include at least one polar group, thereby further improving lithium ion conductivity.

In Chemical Formula 1, x represents the number of units (hereinafter referred to as “first units”) in which the side chains are connected to the backbone, specifically, the number of consecutive first units. x may be an integer ranging from about 1 to about 500, for example, from about 1 to about 400, from about 1 to about 300, from about 1 to about 200, or from about 2 to about 200.

In Chemical Formula 1, y represents the number of units (hereinafter referred to as “second units”) having only the backbone without the side chains, specifically, the number of consecutive second units. y may be an integer ranging from about 0 to about 500, for example, from about 0 to about 400, from about 0 to about 300, or from about 0 to about 200.

In Chemical Formula 1, t represents the number of repeating units consisting of only the first units, or the number of repeating units consisting of the first units and the second units. t may be an integer ranging from about 1 to about 500, for example, from about 2 to about 500, from about 5 to about 400, from about 10 to about 300, or from about 15 to about 200. Within this range of t, the length of the backbone can be variously controlled, and when t is within the above range, the deposition characteristics of lithium ions on the surface of the negative electrode and lithium ion conductivity can be improved.

Also, in Chemical Formula 1, ⅛≤x/(x+y)≤1 may be satisfied, for example, ⅙≤x/(x+y)≤1. The aforementioned packing density of side chains can be defined as the value of x/(x+y) in Chemical Formula 1. That is, the ratio of the number of the first units to the sum of the numbers of the first and second units is equal to the packing density of side chains.

That is, the lower the value of x/(x+y) within the above range, i.e., the lower the packing density of side chains, the larger the spacing between the side chains, i.e., the flexible-bent structure can be achieved. Conversely, the higher the value of x/(x+y) within the above range, i.e., the higher the packing density of side chains, the smaller the spacing between the side chains, i.e., the rigid-rod-like structure can be achieved.

The bottlebrush polymer having a structure in which the repeating unit represented by Chemical Formula 1 is included and the side chains included in the repeating unit are arranged at a constant interval can have excellent lithium ion conductivity by uniformly and densely depositing lithium ions on a surface of a negative electrode.

For example, a bottlebrush polymer may include a repeating unit where y is about 0 to about 7 when x is about 1 in Chemical Formula 1, for example, a repeating unit where y is about 1 to about 7 when x is about 1, or where y is about 2 to about 7 when x is about 1.

For example, the bottlebrush polymer may include at least one of a compound including a structural unit represented by Chemical Formula 2, a compound including a structural unit represented by Chemical Formula 3, and a compound including a structural unit represented by Chemical Formula 4. For example, the bottlebrush polymer may be the compound including the structural unit represented by Chemical Formula 3, or the compound including the structural unit represented by Chemical Formula 4.

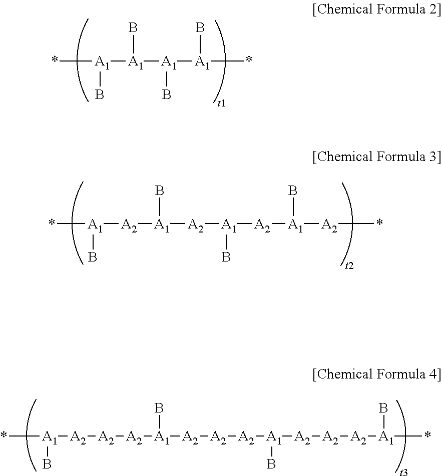

In Chemical Formulas 2 to 4, A₁, A₂ and B may be the same as defined in Chemical Formula 1, and

In Chemical Formulas 2 to 4, t1 to t3 represent the number of each structural unit and is each an integer ranging from about 1 to about 500.

Specifically, a compound including a structural unit represented by Chemical Formula 2 has a constant spacing between side chains represented by B, and corresponds to a case where the value of x/(x+y) in Chemical Formula 1 is about 1, i.e., a case where the packing density of side chains is about 1. A compound including a structural unit represented by Chemical Formula 3 has a constant spacing between side chains and corresponds to a case where the value of x/(x+y) in Chemical Formula 1 is about ½, i.e., a case where the packing density of side chains is about ½. A compound including a structural unit represented by Chemical Formula 4 has a constant spacing between side chains and corresponds to a case where the value of x/(x+y) in Chemical Formula 1 is about ¼, i.e., a case where the packing density of side chains is about ¼.

For example, the bottlebrush polymer may include at least one of a repeating unit represented by Chemical Formula 5 and a repeating unit represented by Chemical Formula 6.

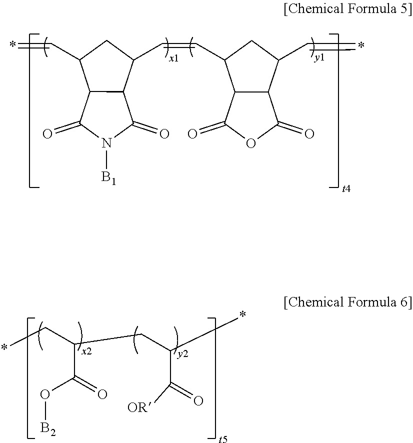

In Chemical Formulas 5 and 6, B₁ and B₂ corresponding to the side chains may each be side chains which are a substituted or unsubstituted C1 to C20 alkyl group, wherein at least one —CH₂— of the alkyl group may be replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R may be a substituted or unsubstituted C1 to C20 haloalkylene group.

In Chemical Formulas 5 and 6, x1 and x2 may each be an integer ranging from about 1 to about 500, for example, from about 1 to about 400, from about 1 to about 300, or from about 1 to about 200.

In Chemical Formulas 5 and 6, y1 and y2 may each be an integer ranging from about 0 to about 500, for example, from about 0 to about 400, from about 0 to about 300, or from about 0 to about 200.

In Chemical Formulas 5 and 6, t4 and t5 may each be an integer ranging from about 1 to about 500, for example, from about 5 to about 400, from about 10 to about 300, or from about 15 to about 200.

In Chemical Formula 6, R′ may be a substituted or unsubstituted C1 to C20 alkyl group.

For example, the side chains, i.e., B in Chemical Formula 1, may include a substituent derived from one or more compounds selected from polyethylene glycol, polypropylene glycol, polycarbonate, polycaprolactone, and perfluoropolyether.

For example, in Chemical Formula 1, B may include at least one substituent selected from Chemical Formulas 7-1 to 7-6.

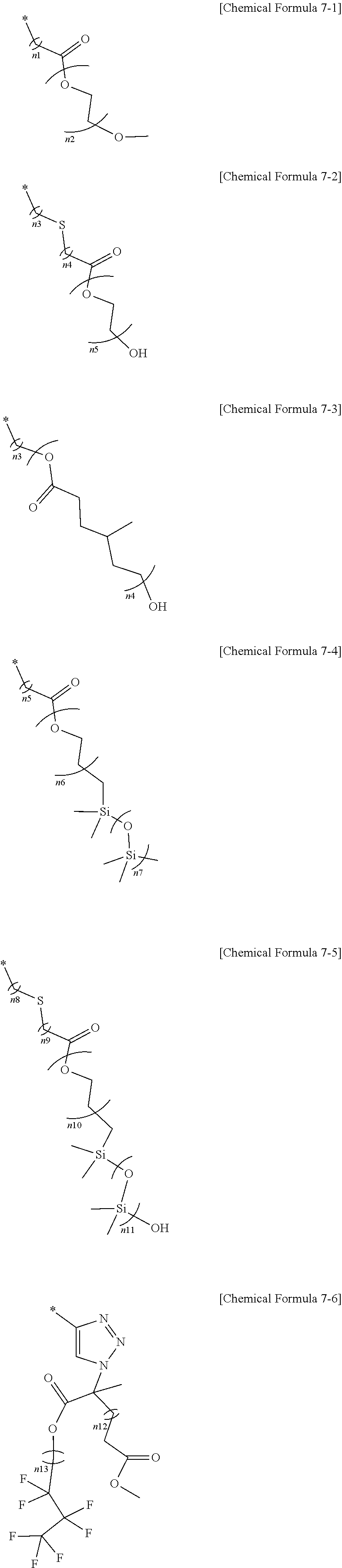

In Chemical Formulas 7-1 to 7-6, n1 to n13 may each be an integer ranging from about 1 to about 20.

As in Chemical Formula 1, the length of the side chains can be controlled, specifically as in the examples of Chemical Formulas 7-1 to 7-6. In addition to controlling the packing density of side chains as described above, lithium ion conductivity can be further improved by controlling the length of the side chains containing the polar group.

The bottlebrush polymer according to an embodiment can be synthesized by a reaction of compounds each inducing the backbone and the side chains defined in Chemical Formula 1. That is, it can be synthesized by the reaction of a compound inducing the backbone, such as norbornene or a norbornene derivative, or an acrylate, and a compound inducing the side chains, such as a C1 to C20 alkane, wherein at least one —CH₂— of the alkane includes a polar group.

In addition, the bottlebrush polymer having a range of the packing density of side chains according to an embodiment can be produced by controlling a mixing ratio of a compound synthesized by reaction of compounds each inducing the backbone and the side chains and selectively a compound inducing the backbone. At this time, the former compound can be mixed in an amount of about 1 mol % to about 100 mol % based on a total amount of the bottlebrush polymer, for example, about 5 mol % to about 100 mol %, or about 10 mol % to about 100 mol %. When mixed within the above ratio range, the bottlebrush polymer having the packing density of side chains in a predetermined range is produced, thereby improving lithium ion conductivity by exhibiting excellent lithium ion deposition characteristics on a surface of a lithium metal.

The aforementioned bottlebrush polymer may be included in an amount of about 0.1 wt % to about 20 wt % based on a total amount of the electrolyte, for example, about 0.5 wt % to about 15 wt % or about 0.5 wt % to about 10 wt %. When the content of the bottlebrush polymer is within the above range, a lithium metal battery having excellent lithium ion conductivity can be obtained, thereby being safe and having excellent life characteristics.

The lithium salt is a substance that acts as a source of lithium ions within the battery, enabling the operation of a basic lithium metal battery, and promotes the movement of lithium ions between the positive and negative electrodes.

The lithium salt may include at least one of LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

The concentration of the lithium salt may be from 0.1 M to 2.0 M. When the concentration of the lithium salt is within the above range, lithium ions may move effectively as the electrolyte has appropriate conductivity and viscosity.

Any organic solvent that can be used in the relevant technical field may be used as the organic solvent.

The organic solvent may include at least one selected from, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, 1,3-dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, and dimethyl ether.

The electrolyte may further include an ionic liquid. The ionic liquid has high solubility in organic solvents and can further increase ionic conductivity.

The ionic liquid may include at least one selected from compounds including i) at least one cation selected from the group consisting of ammonium, pyrrolidinium, pyridinium, pyrimidinium, imidazolium, piperidinium, pyrazolium, oxazolium, pyridazinium, phosphonium, sulfonium, and triazolium, and ii) at least one anion selected from the group consisting of BF₄⁻, PF₆⁻, AsF₆⁻, SbF₆⁻, AlCl₄⁻, HSO₄⁻, ClO₄⁻, CH₃SO₃⁻; CF₃CO₂⁻, Cl⁻, Br⁻, I₋, F⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may include at least one selected from, for example, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

Hereinafter, a lithium metal battery including the aforementioned electrolyte will be described.

A lithium metal battery according to an embodiment includes a negative electrode including a lithium metal or a lithium metal alloy; a positive electrode; and an electrolyte disposed between the negative electrode and the positive electrode and including the aforementioned electrolyte.

The lithium metal alloy used in the negative electrode may be an alloy composed of lithium and at least one metal selected from Na, K, Rb, Cs, Fr, Be, Mg, Ca, Sr, Ba, Ra, Al, and Sn.

The positive electrode may include a current collector and a positive electrode active material layer disposed on at least one surface of the current collector. The positive electrode active material layer may include positive electrode active material, binder, selectively conductive material.

The current collector used in the positive electrode may be, for example, aluminum, nickel, etc., but is not limited thereto.

A compound capable of reversible intercalation and deintercalation of lithium may be used as the positive electrode active material. Specifically, at least one of a composite oxide or a composite phosphorus oxide of a metal such as cobalt, manganese, nickel, aluminum, iron or a combination thereof and lithium may be used. More specifically, lithium cobalt oxide, lithium nickel oxide, lithium manganese oxide, lithium nickel cobalt manganese oxide, lithium nickel cobalt aluminum oxide, lithium iron phosphate or a combination thereof may be used.

The binder serves to attach particles of the positive electrode active material well to each other and to attach the positive electrode active material well to the current collector. The binder may include, for example, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, polyamideimide, polyacrylic acid, and the like, but is not limited thereto.

The conductive material may be used to provide conductivity to the electrode, and any material that does not cause chemical changes and is electronically conductive may be used. The conductive material may be, for example, natural graphite, artificial graphite, carbon black, acetylene black, Ketjen black, carbon fiber, metal powder such as copper, nickel, aluminum, or silver, metal fiber, etc., and may also be mixed and used with one or more types of conductive materials such as polyphenylene derivatives.

The lithium metal battery according to an embodiment may further include a separator.

The separator may include a polyolefin porous substrate. The polyolefin porous substrate has a large number of pores and may be a substrate typically used in electrochemical devices. The polyolefin porous substrate may have excellent shutdown functions and may contribute to improving battery safety.

The polyolefin porous substrate may be selected from the group consisting of, for example, a polyethylene monolayer, a polypropylene monolayer, a polyethylene/polypropylene bilayer, a polypropylene/polyethylene/polypropylene trilayer, and a polyethylene/polypropylene/polyethylene trilayer. Additionally, the polyolefin porous substrate may include a non-olefin resin in addition to an olefin resin, or may include a copolymer of olefin and non-olefin monomers.

The lithium metal battery according to an embodiment may be cylindrical, square, coin-shaped, pouch-shaped, etc., and may have any shape, such as a bulk type or a thin film type. The lithium metal battery according to an embodiment may be widely applied to mobile devices, IT devices, automobiles, etc.

Hereinafter, the embodiments are illustrated in more detail with reference to examples. However, these examples are exemplary, and the scope of claims is not limited thereto.

### (Preparation of Bottlebrush Polymer)

### Synthesis Example 1

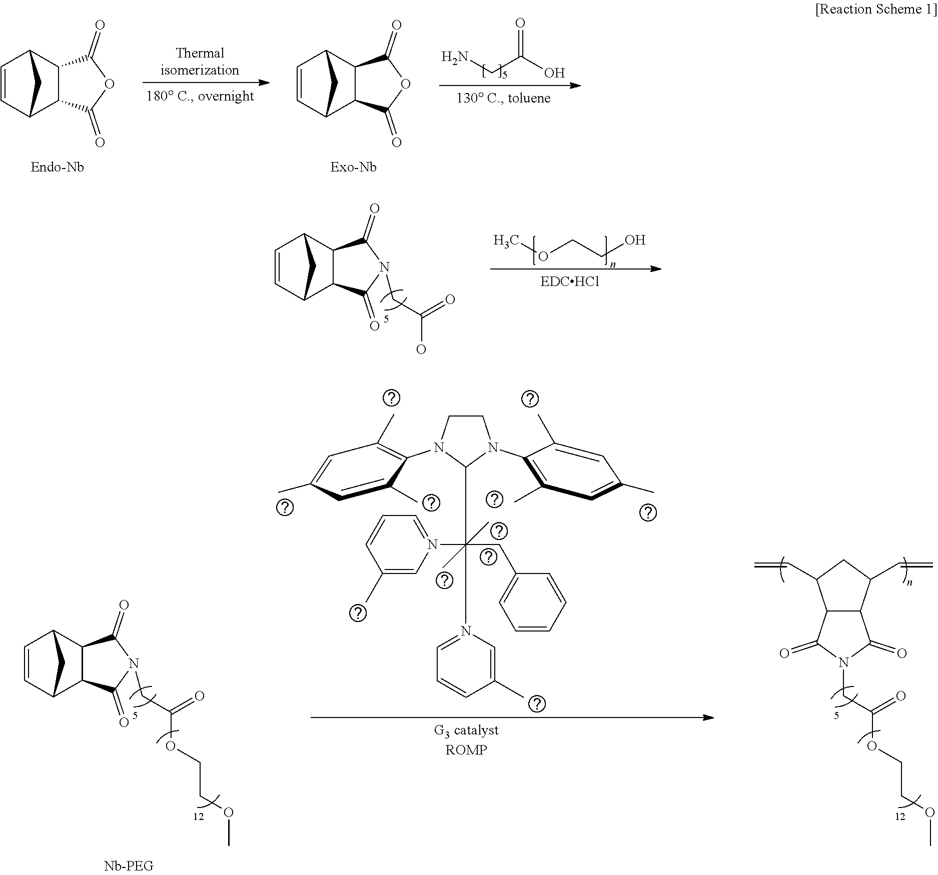

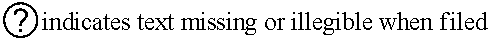

8 g (0.049 mol) of cis-5-norbornene-exo-2,3-dicarboxylic anhydride (Exo-Nb), 6.39 g (0.049 mol) of 6-aminohexanoic acid, and 50 mL of toluene were mixed in a round-bottom flask equipped with a stirring bar and a reflux condenser. The mixture was heated to 130° C. and refluxed overnight, cooled to room temperature, and toluene was removed under reduced pressure using a rotary evaporator. The remaining product was dissolved in 100 mL of dichloromethane, extracted three times with 100 mL of 0.1M HCl aqueous solution, extracted three times with saturated NaCl aqueous solution, and then dried. 1.525 g (0.006 mol) of the product thus obtained, 2.75 g (0.005 mol) of polyethylene glycol, and 1.44 g (0.008 mol) of (3-dimethylamino-propyl)-ethyl-carbodiimide hydrochloride (EDC.HCl) were mixed to produce Nb-PEG. The remaining product was dissolved in 100 mL of dichloromethane, extracted three times with 100 ml of 0.1M HCl aqueous solution, extracted three times with saturated NaCl aqueous solution, and then dried. The produced Nb-PEG and Exo-Nb were mixed in a certain ratio, dissolved in a dichloromethane solvent, and then ring-opening polymerization was performed under a ring-opening metathesis polymerization (ROMP) catalyst to obtain the final product.

The final product is a bottlebrush polymer obtained by reacting 75 mol % of Exo-Nb and 25 mol % of Nb-PEG in Reaction Scheme 1, and including a repeating unit represented by Chemical Formula 8.

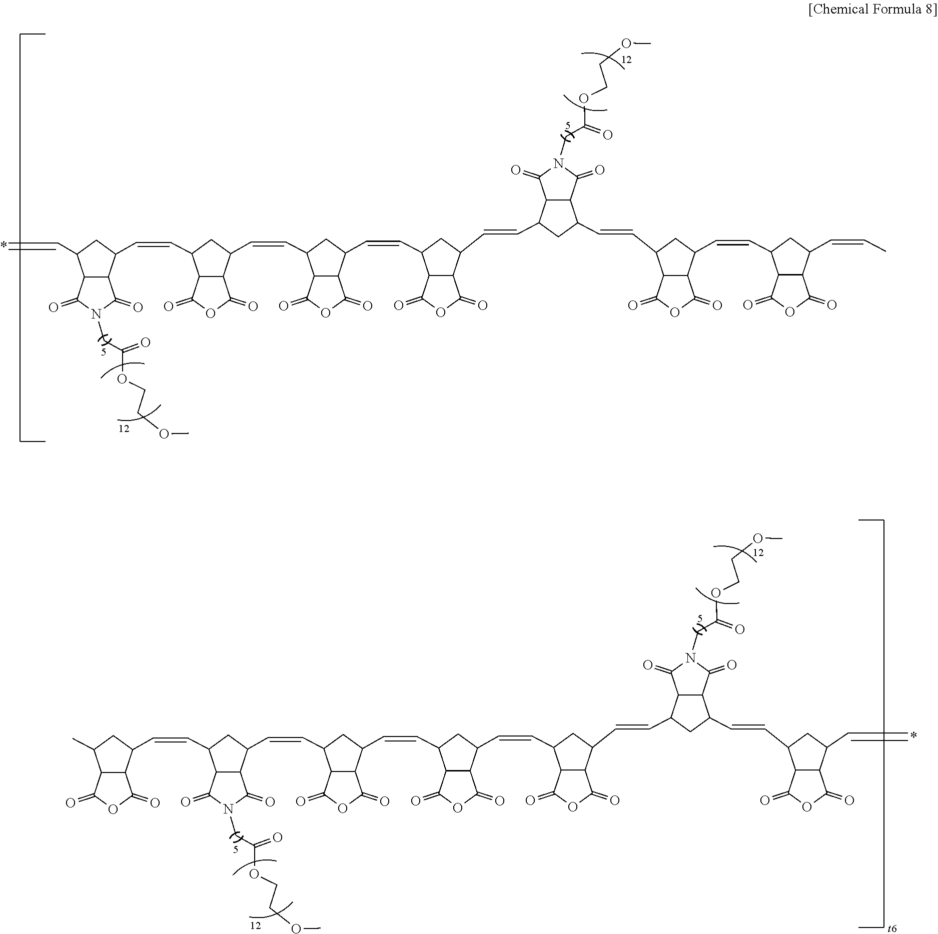

(In Chemical Formula 8, 16 is 75.)

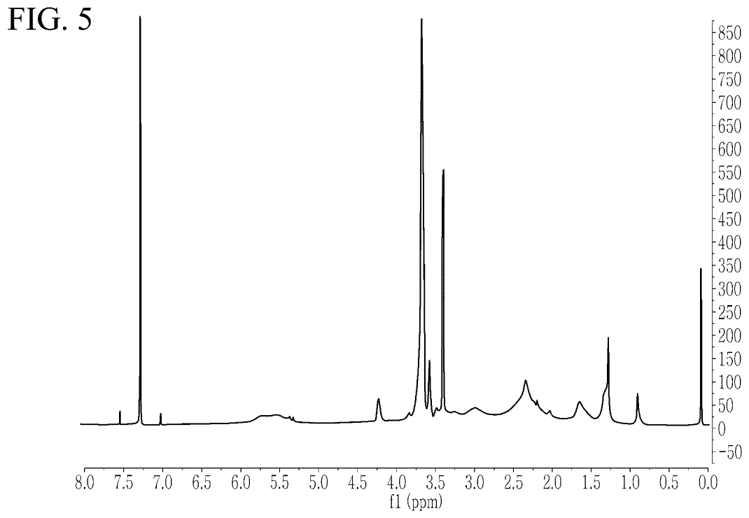

The NMR spectrum of the bottlebrush polymer including the repeating unit represented by Chemical Formula 8 was shown in FIG. 5. FIG. 5 is an NMR spectrum of the bottlebrush polymer synthesized in Synthesis Example 1.

### Synthesis Example 2

In Reaction Scheme 1, 50 mol % of Exo-Nb and 50 mol % of Nb-PEG were reacted to synthesize a bottlebrush polymer including a repeating unit represented by Chemical Formula 9.

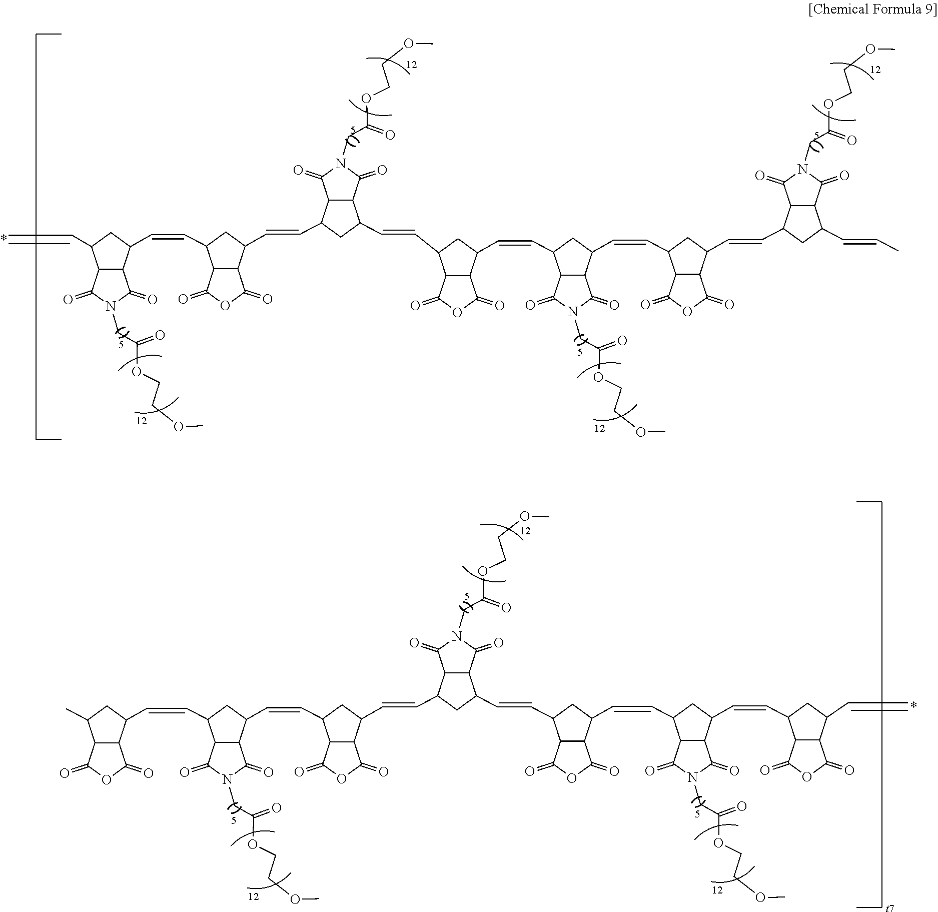

(In Chemical Formula 9, 17 is 150.)

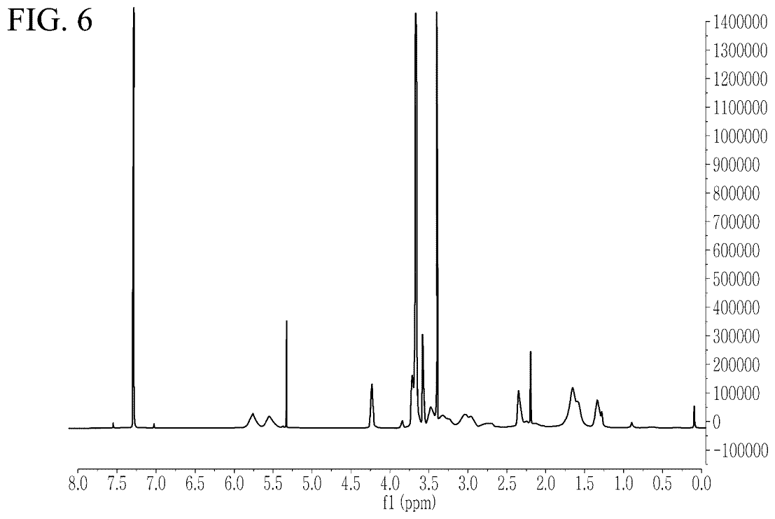

The NMR spectrum of the bottlebrush polymer including the repeating unit represented by Chemical Formula 9 was shown in FIG. 6. FIG. 6 is an NMR spectrum of the bottlebrush polymer synthesized in Synthesis Example 2.

### Synthesis Example 3

In Reaction Scheme 1, 100 mol % of Nb-PEG was reacted to synthesize a bottlebrush polymer including a repeating unit represented by Chemical Formula 10.

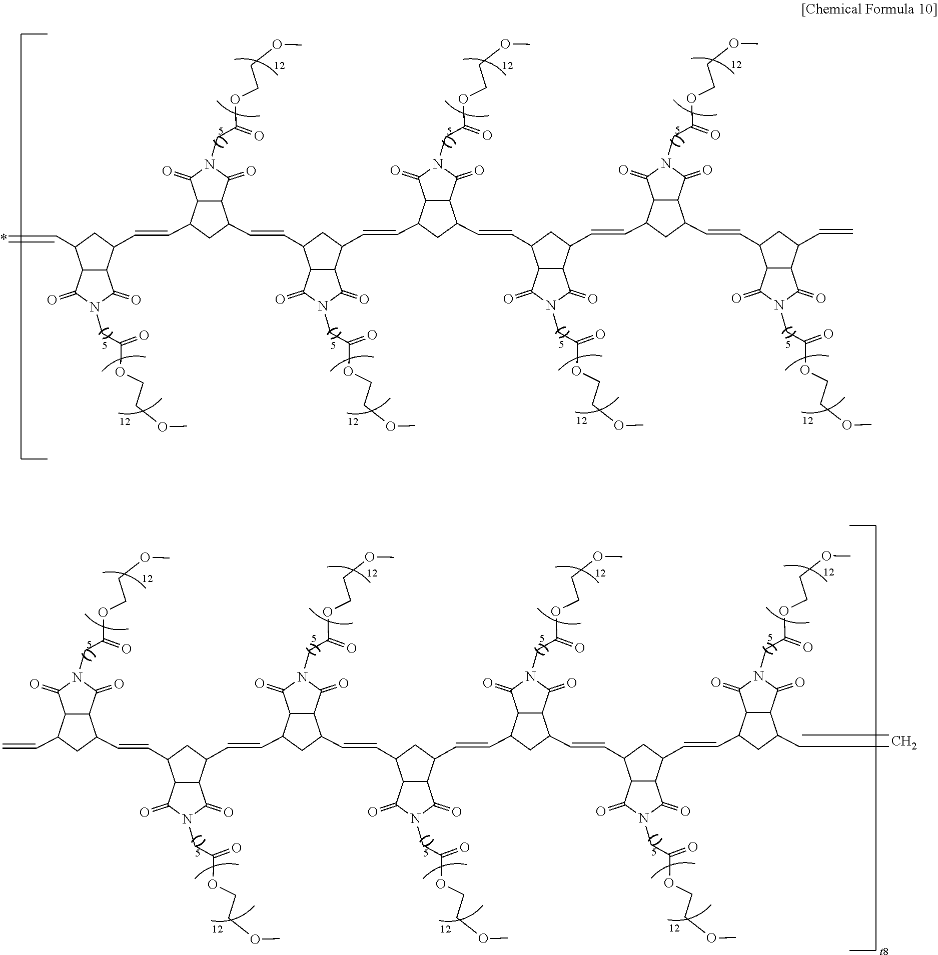

(In Chemical Formula 10, t8 is 300.)

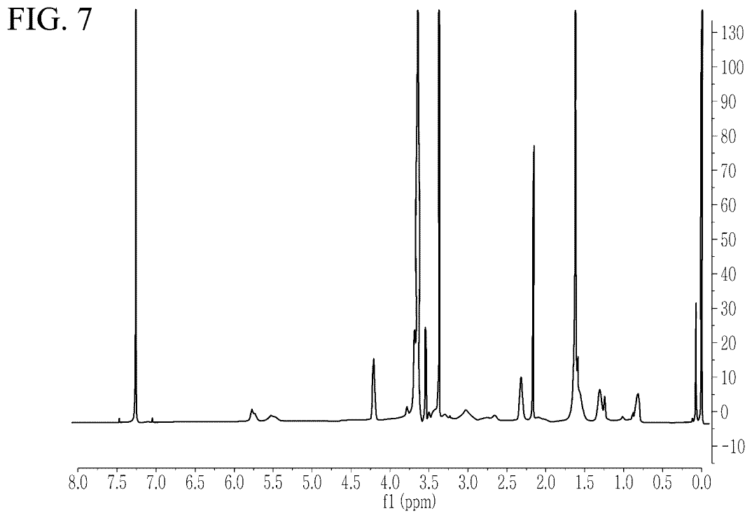

The NMR spectrum of the bottlebrush polymer including the repeating unit represented by Chemical Formula 10 was shown in FIG. 7. FIG. 7 is an NMR spectrum of the bottlebrush polymer synthesized in Synthesis Example 3.

### (Preparation of Electrolyte for Lithium Metal Battery)

### Example 1

An electrolyte was prepared by dissolving 1M lithium bis(fluorosulfonyl)imide (LiN(SO₂F)₂, LiFSI) in 1,2-dimethoxyethane (DME) and adding 0.42 mM of the bottlebrush polymer synthesized in Synthesis Example 1.

### Example 2

An electrolyte was prepared in the same manner as in Example 1, except that the bottlebrush polymer synthesized in Synthesis Example 2 was used.

### Example 3

An electrolyte was prepared in the same manner as in Example 1, except that the bottlebrush polymer synthesized in Synthesis Example 3 was used.

### Comparative Example 1

An electrolyte was prepared in the same manner as in Example 1, except that the bottlebrush polymer was not added.

### Comparative Example 2

An electrolyte was prepared in the same manner as in Example 1, except that linear polyethylene glycol (PEG) was used instead of the bottlebrush polymer.

### Evaluation 1: SEM Analysis

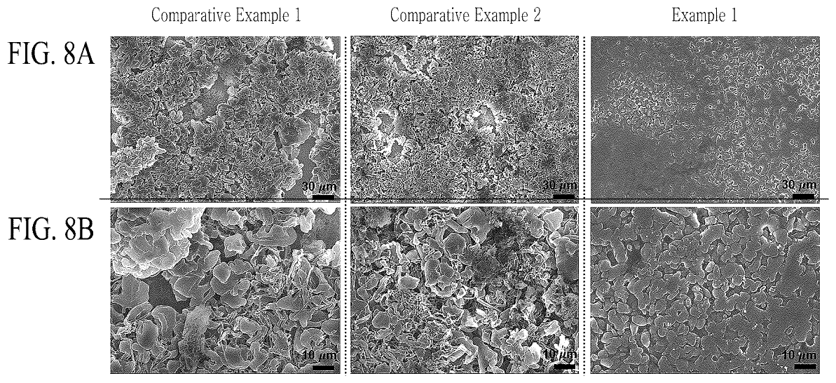

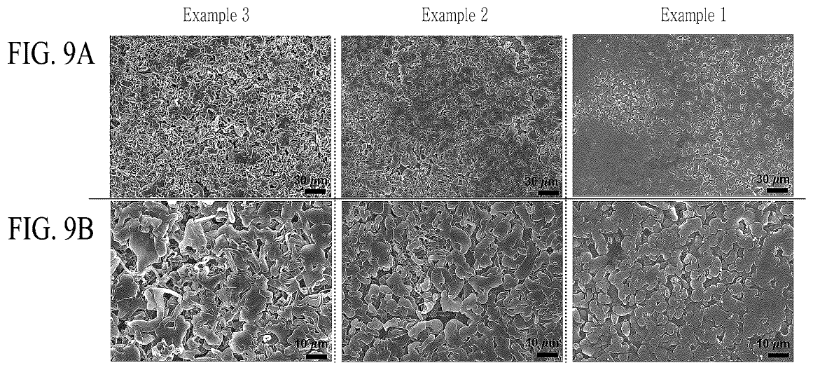

A half lithium metal battery was manufactured using lithium metal as a negative electrode and a positive electrode, respectively, and the electrolytes prepared in Examples 1 to 3 and Comparative Examples 1 and 2. A single charge/discharge cycle was performed on the manufactured lithium metal battery under the conditions of 0.5 mA/cm² and 0.5 mAh/cm². Before and after one cycle, SEM (scanning electron microscope) analysis was performed on the surface of the negative electrode, and the results were shown in FIGS. 8A, 8B, 9A and 9B. SEM analysis was performed using a Hitachi S4800 instrument at 10.0 kV.

FIGS. 8A and 8B are each a scanning electron microscope (SEM) analysis image showing the surface of lithium metal negative electrodes according to Example 1 and Comparative Examples 1 and 2. FIGS. 9A and 9B are each a scanning electron microscope (SEM) analysis image showing the surface of lithium metal negative electrodes according to Examples 1 to 3. FIG. 8B is enlarged view of FIG. 8A, and FIG. 9B is enlarged view of FIG. 9A.

Referring to FIGS. 8A and 8B, Example 1 in which the bottlebrush polymer according to an embodiment was added to the electrolyte and used, it can be confirmed that lithium ions were deposited more uniformly and densely on the surface of the lithium metal negative electrode after 1 cycle, compared to Comparative Example 1 in which the bottlebrush polymer was not used and Comparative Example 2 in which linear PEG was used. Accordingly, it can be expected that the cycle stability of a lithium metal battery according to an embodiment will be improved.

In addition, referring to FIGS. 9A and 9B, it can be confirmed that the deposition characteristics of lithium ions can vary depending on the structure of the bottlebrush polymer according to an embodiment. For reference, the bottlebrush polymer used in Examples 1 to 3 have structures in which the spacing between side chains is constant and the packing densities of side chains are ¼, ½, and 1, respectively, as shown in Chemical Formulas 8 to 10. That is, when comparing Examples 1 to 3, it can be seen that the lower the packing density of side chains, the better the deposition characteristics of lithium ions on the surface of the lithium metal negative electrode after 1 cycle.

### Evaluation 2: Cycle Performance

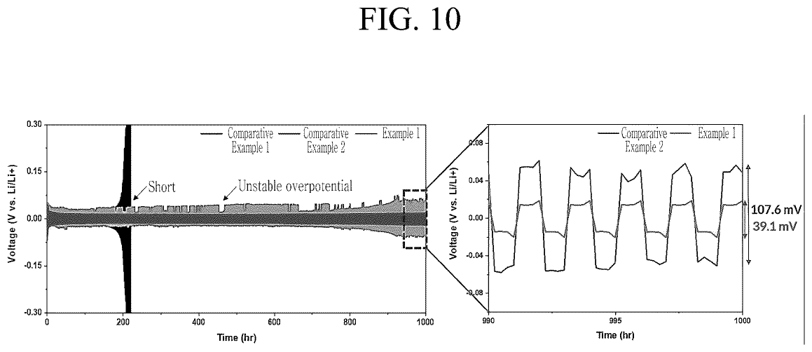

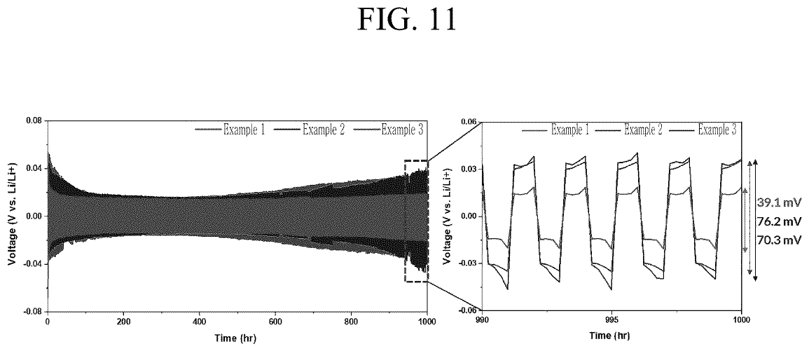

The cycle performance of the lithium metal battery manufactured in Evaluation 1 was evaluated by performing 1,000 charge/discharge cycles under the conditions of 0.5 mA/cm² and 0.5 mAh/cm², and the results were shown in FIGS. 10 and 11.

FIG. 10 is a graph showing the cycle performance of lithium metal batteries according to Example 1 and Comparative Examples 1 and 2. FIG. 11 is a graph showing the cycle performance of lithium metal batteries according to Examples 1 to 3.

Referring to FIG. 10, in the case of Example 1 in which the bottlebrush polymer according to an embodiment was added to the electrolyte and used, it can be confirmed that the cycle stability is superior because there is no occurrence of a short circuit and the overvoltage is low compared to Comparative Example 1 in which the bottlebrush polymer was not used and Comparative Example 2 in which linear PEG was used.

In addition, referring to FIG. 11, it can be seen that Example 1, which used the bottlebrush polymer having the lowest packing density of side chain, has a lower overvoltage and thus better cycle stability than Examples 2 and 3, which had higher packing densities of side chain.

### Evaluation 3: EIS Analysis

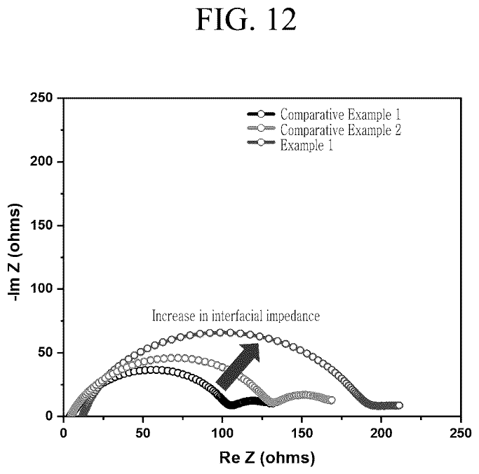

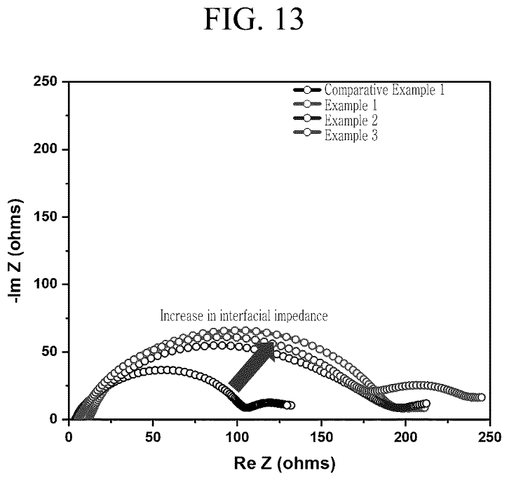

For the lithium metal battery manufactured in Evaluation 1, a precycle was performed under the conditions of 0.1 mA/cm² and 0.4 mAh/cm². After precycling, electrochemical impedance spectroscopy (EIS) analysis was performed, and the results were shown in FIGS. 12 and 13.

EIS analysis was performed using a Biologics VSP-300 potentiostat at a frequency of 5×10⁵ to 5×10−1 Hz and an amplitude of 10 mV.

FIG. 12 is a graph of electrochemical impedance spectroscopy (EIS) analysis of lithium metal batteries according to Example 1 and Comparative Examples 1 and 2. FIG. 13 is a graph of electrochemical impedance spectroscopy (EIS) analysis of lithium metal batteries according to Examples 1 to 3 and Comparative Example 1.

Referring to FIG. 12, in the case of Example 1 in which the bottlebrush polymer according to an embodiment was added to the electrolyte and used, it can be confirmed that the interfacial impedance on the surface of the lithium metal negative electrode significantly increases, compared to Comparative Example 1 in which the bottle-shaped polymer was not used and Comparative Example 2 in which linear PEG was used. Accordingly, it can be seen that the performance of the lithium metal battery according to an embodiment is excellent.

In addition, referring to FIG. 13, in all of the cases of Examples 1 to 3 using the bottlebrush polymer according to an embodiment, it can be confirmed that the interfacial impedance on the surface of the lithium metal negative electrode significantly increases compared to Comparative Example 1 that does not use the bottlebrush polymer.

### Evaluation 4: Electrolyte Viscosity

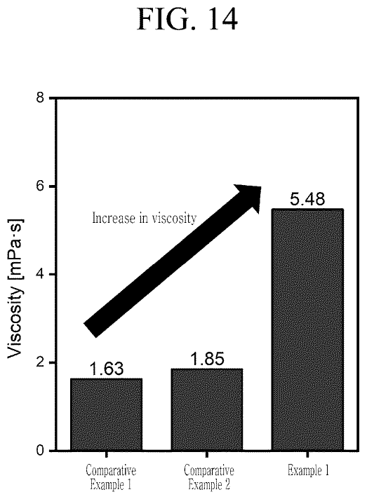

The viscosity of the electrolytes prepared in Examples 1 to 3 and Comparative Examples 1 and 2 was measured, and the results were shown in FIG. 14.

Viscosity was measured using an Anton-Paar MCR-302 rheometer at shear rates of 1 to 100/s.

FIG. 14 is a graph showing the viscosity of the electrolytes according to Example 1 and Comparative Examples 1 and 2.

Referring to FIG. 14, in the case of the electrolyte of Example 1 including the bottlebrush polymer according to an embodiment, it can be confirmed that the viscosity increases compared to Comparative Example 1 that does not use the bottlebrush polymer and Comparative Example 2 that uses linear PEG. Accordingly, it can be seen that the performance of the lithium metal battery according to an embodiment is excellent.

### Evaluation 5: Electrolyte ⁷Li NMR Analysis

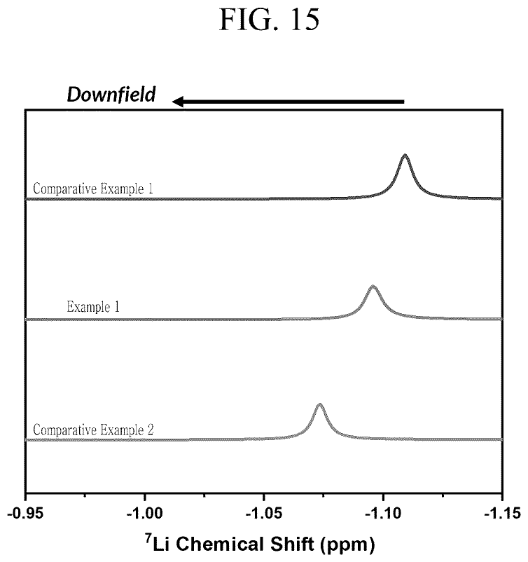

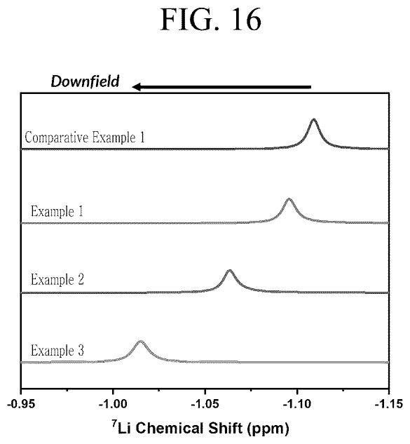

The electrolytes prepared in Examples 1 to 3 and Comparative Examples 1 and 2 were dissolved in a D₂O solution at 25° C. and ⁷Li NMR analysis was performed, and the results were shown in FIGS. 15 and 16.

FIG. 15 is a ⁷Li NMR analysis diagram of the electrolytes according to Example 1 and Comparative Examples 1 and 2. FIG. 16 is a ⁷Li NMR analysis diagram of the electrolytes according to Examples 1 to 3 and Comparative Example 1.

Referring to FIG. 15, it can be seen that the linear PEG used in Comparative Example 2 has a greater interaction with lithium ions than the bottlebrush polymer used in Example 1. This is presumed to be because the bottlebrush polymer has a steric effect due to its structure. In other words, linear PEG can freely transform its structure in solution to form a greater interaction with lithium ions, whereas the bottlebrush polymer cannot freely transform due to steric hindrance between polymers existing as side chains, and thus only partial interaction with lithium ions is possible.

Meanwhile, referring to FIG. 16, it can be seen that the bottlebrush polymer used in Example 3 has a greater interaction with lithium ions than in Examples 1 and 2, and this can be seen because the bottlebrush polymer used in Example 3 has the largest number of side chains.

### Evaluation 6: Rate Capability

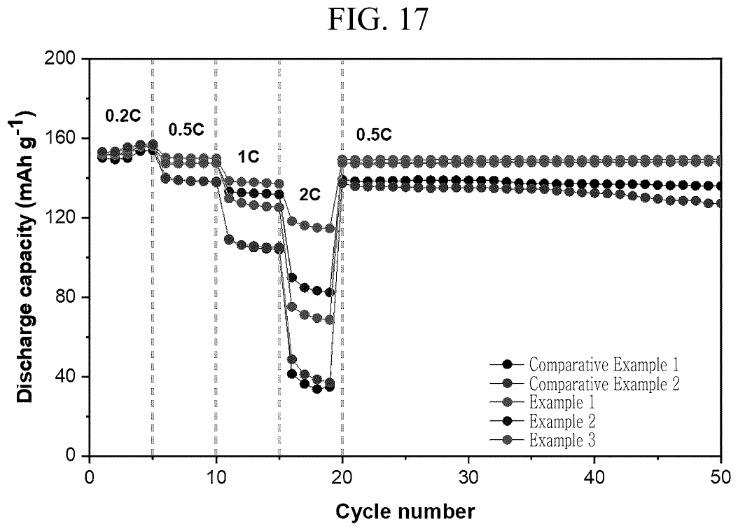

A lithium metal battery was manufactured using LiFePO₄ having a discharge capacity of 160 mAh/g as a positive electrode active material to form a positive electrode, lithium metal as a negative electrode, and the electrolytes prepared in Examples 1 to 3 and Comparative Examples 1 and 2. The manufactured lithium metal battery was subjected to 50 charge/discharge cycles. Specifically, charge and discharge were performed at 0.2C for cycles 1 to 5, 0.5C for cycles 6 to 10, 1C for cycles 11 to 15, 2C for cycles 16 to 20, and 0.5C from cycle 21. After cycling, the rate capability of the battery was measured, and the results were shown in FIG. 17.

FIG. 17 is a graph showing the rate capability of lithium metal batteries according to Examples 1 to 3 and Comparative Examples 1 and 2.

Referring to FIG. 17, in the cases of Examples 1 to 3 in which the bottlebrush polymer according to an embodiment was added to the electrolyte and used, it can be confirmed that the rate capability of the lithium metal battery is superior compared to Comparative Example 1 in which the bottlebrush polymer was not used and Comparative Example 2 in which linear PEG was used.

### Evaluation 7: Cycle Durability

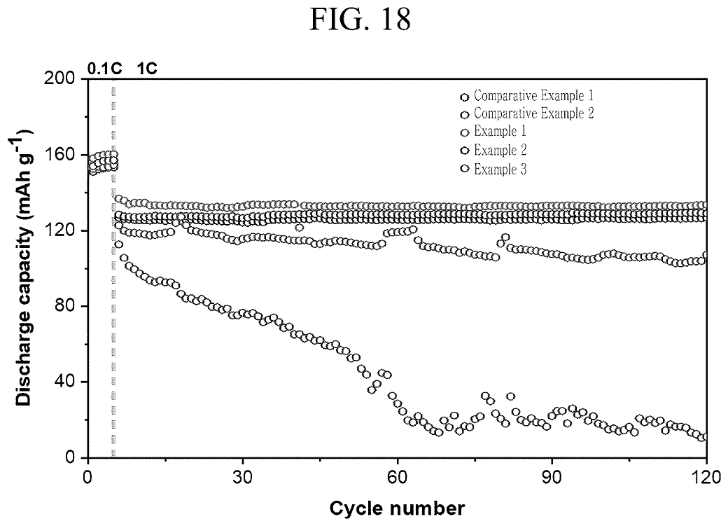

For the lithium metal battery manufactured in Evaluation 6, 120 charge/discharge cycles were performed. Specifically, charge/discharge was performed at 0.1C for cycles 1 to 5, and at 1C from cycle 6. After cycling, the cycle durability of the battery was measured, and the results were shown in FIG. 18.

FIG. 18 is a graph showing the cycle durability of lithium metal batteries according to Examples 1 to 3 and Comparative Examples 1 and 2.

Referring to FIG. 18, in the cases of Examples 1 to 3 in which the bottlebrush polymer according to an embodiment was added to the electrolyte and used, it can be confirmed that the cycle durability of the lithium metal battery is superior compared to Comparative Example 2 in which linear PEG was used.

### Evaluation 8: Coulomb Efficiency

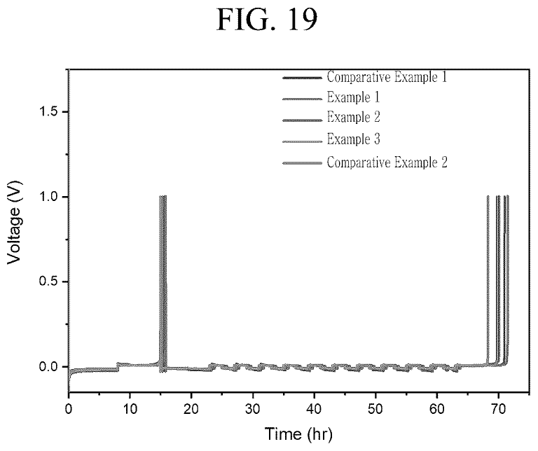

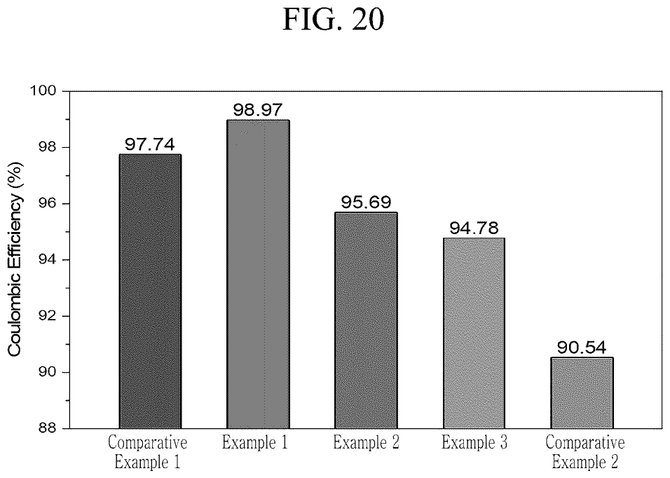

A Li/Cu asymmetric lithium metal battery was manufactured using lithium metal as a negative electrode and the electrolytes prepared in Examples 1 to 3 and Comparative Examples 1 and 2. The Coulombic efficiency of the manufactured lithium metal battery was measured by the following method, and the results were shown in FIGS. 19 and 20.

4 mAh/cm² of lithium metal was electrochemically deposited on the surface of copper foil under the conditions of 0.5 mA/cm² and desorbed at 1V. Subsequently, 4 mAh/cm² of lithium metal was deposited again on the copper foil under the condition of 0.5 mA/cm². Subsequently, lithium metal was repeatedly deposited and desorbed at 1 mAh/cm² under the conditions of 0.5 mA/cm² for 10 cycles. Subsequently, all lithium metal was desorbed at 1 V.

FIG. 19 is a graph showing voltage changes over time in lithium metal batteries according to Examples 1 to 3 and Comparative Examples 1 and 2. FIG. 20 is a graph showing the coulombic efficiency of lithium metal batteries according to Examples 1 to 3 and Comparative Examples 1 and 2.

Referring to FIGS. 19 and 20, in the cases of Examples 1 to 3 in which the bottlebrush polymer according to an embodiment was added to the electrolyte and used, it can be confirmed that the coulombic efficiency of the lithium metal battery is superior compared to Comparative Example 2 in which linear PEG was used.

### Evaluation 9: Nucleation Overpotential

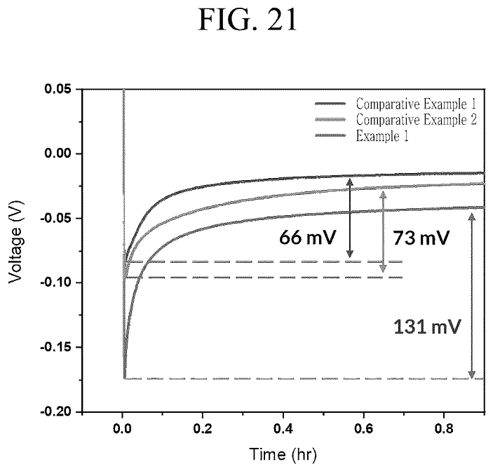

For the lithium metal battery manufactured in Evaluation 8, one charge/discharge cycle was performed under the conditions of 0.5 mA/cm² and 0.5 mAh/cm², and the nucleation overvoltage during lithium deposition was measured, and the results were shown in FIG. 21.

FIG. 21 is a graph showing the nucleation overvoltage of lithium metal batteries according to Example 1 and Comparative Examples 1 and 2.

Referring to FIG. 21, in the case of Example 1 in which the bottlebrush polymer according to an embodiment was added to the electrolyte and used, it can be confirmed that the nucleation overvoltage is high compared to Comparative Example 1 in which the bottlebrush polymer was not used and Comparative Example 2 in which linear PEG was used. Accordingly, as Li nuclei are formed in a small size, dense and uniform Li deposition occurs, thereby ensuring stable cycle performance.

### Evaluation 10: Exchange Current Density

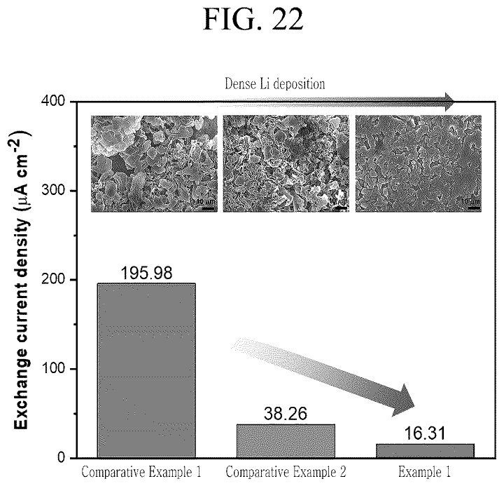

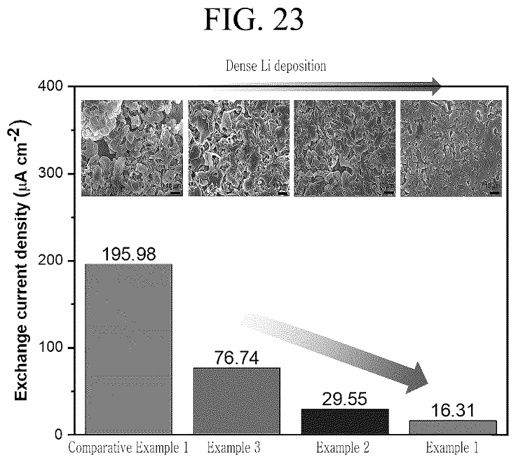

The exchange current density was measured for the lithium metal battery manufactured in Evaluation 1, and the results were shown in FIGS. 22 and 23.

Specifically, linear sweep voltammetry (LSV) was performed at a rate of 1 mV/s using a Biologics VSP-300 EIS.

FIG. 22 is a graph showing the exchange current density of lithium metal batteries according to Example 1 and Comparative Examples 1 and 2. FIG. 23 is a graph showing the exchange current density of lithium metal batteries according to Examples 1 to 3 and Comparative Example 1.

Referring to FIG. 22, in the case of Example 1 in which the bottlebrush polymer according to an embodiment was added to the electrolyte and used, it can be seen that the exchange current density of the lithium metal battery is lower compared to Comparative Example 1 in which the bottlebrush polymer was not used and Comparative Example 2 in which linear PEG was used. From this, it can be seen that, according to an embodiment, lithium ions are uniformly and densely deposited on the surface of the lithium metal negative electrode.

In addition, referring to FIG. 23, it can be seen that the exchange current density of the lithium metal battery in Examples 1 to 3 using the bottlebrush polymer according to an embodiment is lower than that in Comparative Example 1 that does not use the bottlebrush polymer. In addition, when comparing Examples 1 to 3, it can be seen that as the packing density of side chains in the bottlebrush polymer decreases, the exchange current density of the lithium metal battery decreases. From this, it can be seen that as the packing density of side chains in the bottlebrush polymer decreases, the surface coverage of the lithium metal becomes better as it has a more flexible-bent structure.

### Evaluation 11: Raman Spectrum Analysis

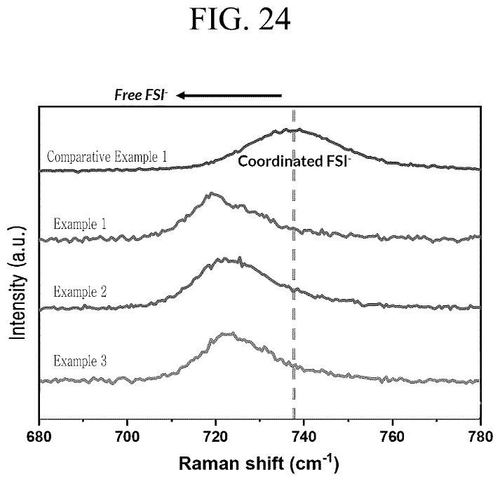

Raman spectrum analysis was performed at 25° C. on the electrolytes prepared in Examples 1 to 3 and Comparative Example 1, and the results were shown in FIG. 24.

FIG. 24 is a Raman spectrum analysis diagram of the electrolytes according to Examples 1 to 3 and Comparative Example 1.

Referring to FIG. 24, it can be seen that the bottlebrush polymer used in Examples 1 to 3 shifts the Raman shift of the electrolyte toward the region of free FSI anions.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. An electrolyte for a lithium metal battery, comprising
a lithium salt;
an organic solvent; and
a bottlebrush polymer comprising a repeating unit represented by Chemical Formula 1,
wherein the bottlebrush polymer has a bottlebrush-shaped structure in which side chains included in the repeating unit are connected to a backbone included in the repeating unit and are arranged in an outward direction, and the spacing between the side chains is evenly arranged, and
a packing density of side chains defined by the value of x/(x+y) in Chemical Formula 1 is ⅛ to 1. 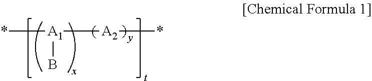
(In Chemical Formula 1,
A₁ and A₂ are each independently a backbone which is a linking group formed by ring opening of norbornene or a norbornene derivative, or a linking group derived from acrylate,
B is a side chain which is a substituted or unsubstituted C1 to C20 alkyl group, wherein at least one —CH₂— of the alkyl group is replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R is a substituted or unsubstituted C1 to C20 haloalkylene group,
x is an integer ranging from 1 to 500,
y is an integer ranging from 0 to 500,
t is an integer ranging from 1 to 500.)

2. The electrolyte for a lithium metal battery of claim 1, wherein
the bottlebrush polymer comprises a repeating unit in which y is 0 to 7 when x is 1 in Chemical Formula 1.

3. The electrolyte for a lithium metal battery of claim 1, wherein
the packing density of side chains is ¼ to 1.

4. The electrolyte for a lithium metal battery of claim 1, wherein
the bottlebrush polymer has a structure in which the side chains adjacent to each other are arranged in different directions facing outward.

5. The electrolyte for a lithium metal battery of claim 1, wherein
the bottlebrush polymer has a flexible-bent structure or a rigid-rod-like structure.

6. The electrolyte for a lithium metal battery of claim 1, wherein
the bottlebrush polymer comprises at least one of a compound comprising a structural unit represented by Chemical Formula 2, a compound comprising a structural unit represented by Chemical Formula 3, and a compound comprising a structural unit represented by Chemical Formula 4. 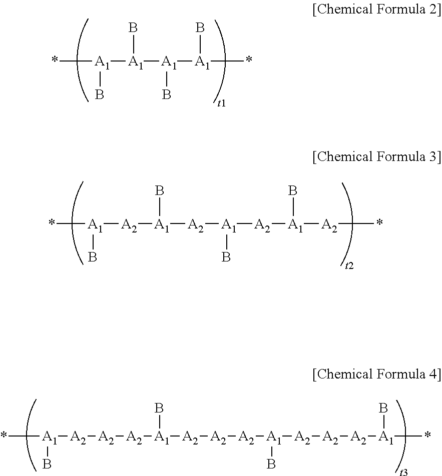
(In Chemical Formulas 2 to 4,
A₁, A₂ and B are the same as defined in Chemical Formula 1, and
t1 to t3 are each an integer ranging from 1 to 500.)

7. The electrolyte for a lithium metal battery of claim 1, wherein
the bottlebrush polymer comprises at least one of a repeating unit represented by Chemical Formula 5 and a repeating unit represented by Chemical Formula 6. 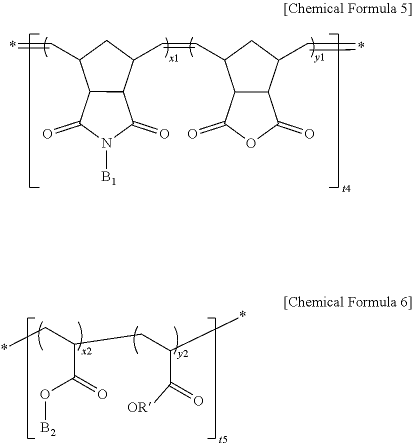
(In Chemical Formulas 5 and 6,
R′ is a substituted or unsubstituted C1 to C20 alkyl group,
B₁ and B₂ are each side chains which are a substituted or unsubstituted C1 to C20 alkyl group, wherein at least one —CH₂— of the alkyl group is replaced by a substituted or unsubstituted C1 to C20 oxyalkylene group, —O—, —CO—, —CO—O—, —O—CO—, —S—, —Si—, —O—Si—, —R—O—R—, a linking group derived from a heterocyclic compound, or a linking group derived from bisphenol A, wherein R is a substituted or unsubstituted C1 to C20 haloalkylene group,
x1 and x2 are each an integer ranging from 1 to 500,
y1 and y2 are each an integer ranging from 0 to 500, and
t4 and t5 are each an integer ranging from 1 to 500.)

8. The electrolyte for a lithium metal battery of claim 1, wherein
in Chemical Formula 1, B comprises a substituent derived from at least one compound selected from the group consisting of polyethylene glycol, polypropylene glycol, polycarbonate, polycaprolactone, and perfluoropolyether.

9. The electrolyte for a lithium metal battery of claim 1, wherein
in Chemical Formula 1, B comprises at least one substituent selected from Chemical Formulas 7-1 to 7-6. 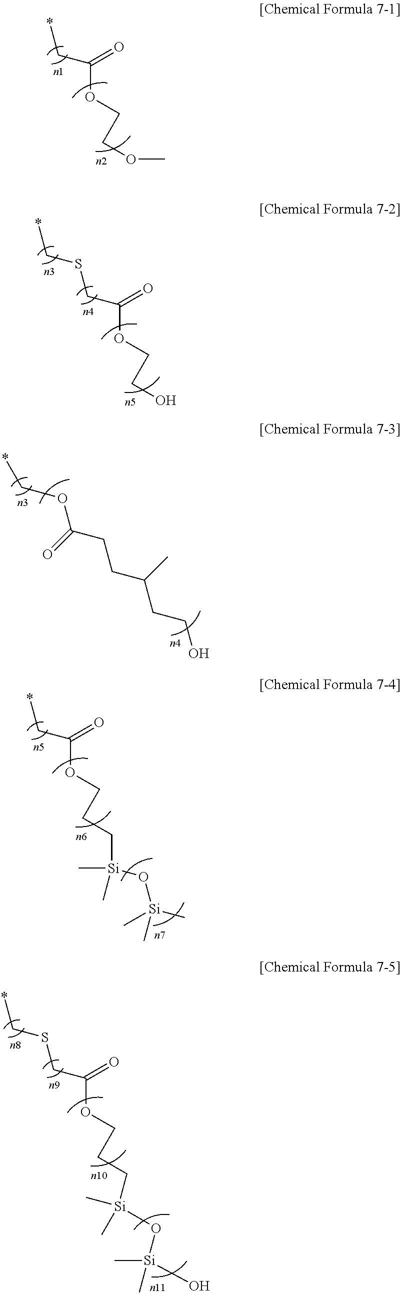 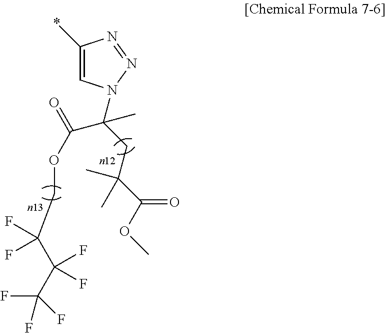
(In Chemical Formulas 7-1 to 7-6,
n1 to n13 are each an integer ranging from 1 to 20.)

10. The electrolyte for a lithium metal battery of claim 1, wherein
the bottlebrush polymer is included in an amount of 0.1 wt % to 20 wt % based on a total amount of the electrolyte.

11. The electrolyte for a lithium metal battery of claim 1, wherein
the lithium salt comprises at least one of LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

12. The electrolyte for a lithium metal battery of claim 1, wherein
the organic solvent comprises at least one selected from the group consisting of propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, 1,3-dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, and dimethyl ether.

13. The electrolyte for a lithium metal battery of claim 1, wherein
the electrolyte further comprises an ionic liquid.

14. The electrolyte for a lithium metal battery of claim 13, wherein
the ionic liquid comprises at least one selected from compounds including i) at least one cation selected from the group consisting of ammonium, pyrrolidinium, pyridinium, pyrimidinium, imidazolium, piperidinium, pyrazolium, oxazolium, pyridazinium, phosphonium, sulfonium, and triazolium, and ii) at least one anion selected from the group consisting of BF₄⁻, PF₆⁻, AsF₆⁻, SbF₆⁻, AlCl₄⁻,
HSO₄⁻, ClO₄⁻, CH₃SO₃⁻, CF₃CO₂⁻, Cl⁻, Br⁻, I⁻, F⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

15. A lithium metal battery, comprising
a negative electrode comprising a lithium metal or a lithium metal alloy;
a positive electrode; and
the electrolyte of claim 1 disposed between the negative electrode and the positive electrode.
